(19) United States
(12) Patent Application Publication
(10) Pub. No.: US 2009/0162732 A1
(43) Pub. Date: Jun. 25, 2009

(54) FUEL CELL EMPLOYING PERIMETER GASKET WITH PERCEIVABLE ORIENTATION INDICATOR

(76) Inventors: Marc Noblet, Paris (FR); Claude D. Moreau, Salernes (Var) (FR); Gilles O. Moreau, Colombes (FR); David B. Descoins, Belle Eglise (FR); Patrick A. Moret, Villennes Sur Seine (FR)

Correspondence Address: 3M INNOVATIVE PROPERTIES COMPANY, PO BOX 33427, ST. PAUL, MN, 55133-3427, US

(21) Appl. No.: 11/962,274

(22) Filed: Dec. 21, 2007

(51) Int. Cl. H01M 8/02

(52) U.S. Cl. 429/35; 29/623.1

(57) ABSTRACT

A fuel cell assembly includes a first flow field plate (FFP), a second FFP, and a membrane electrode assembly (MEA) provided between the first and second FFPs. The MEA includes first and second gas diffusion layers (GDLs) and a membrane provided between an anode catalytic layer and a cathode catalytic layer. A gasket, provided between the first and second flow field plates and relative to a periphery of the MEA, comprises a first surface having a first human perceivable feature associated with the anode catalytic layer and a second surface having a second human perceivable feature associated with the cathode catalytic layer. At least a portion of the gasket comprising the first and second human perceivable features is configured to extend beyond a periphery of the first and second flow field plates.

### FIELD OF THE INVENTION

The present invention relates generally to fuel cell assemblies and methods of assembly that employ a perimeter gasket that incorporates a user perceivable orientation indicator.

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange member (PEM) with gas diffusion layers on either side of the proton exchange member. Anode and cathode catalyst layers are respectively positioned between the gas diffusion layers and the PEM. This unit is referred to as a membrane electrode assembly (MEA). Separator plates (also referred to herein and flow field plates or bipolar plates) are respectively positioned on the outside of the gas diffusion layers of the membrane electrode assembly. This type of fuel cell is often referred to as a PEM fuel cell.

The reaction in a single MEA typically produces less than one volt. Therefore, to obtain operating voltages useful in most applications, a plurality of the MEAs may be stacked and electrically connected in series to achieve a desired voltage. Electrical current is collected from the fuel cell stack and used to drive a load. Fuel cells may be used to supply power for a variety of applications, ranging from automobiles to laptop computers.

The efficiency of the fuel cell power system depends on the flow of reactant gases across the surfaces of the MEA as well as the integrity of the various contacting and sealing interfaces within individual fuel cells of the fuel cell stack. Such contacting and sealing interfaces include those associated with the transport of fuels, coolants, and effluents within and between fuel cells of the stack. Proper positional alignment of fuel cell components and assemblies within a fuel cell stack is critical to ensure efficient operation of the fuel cell system.

### SUMMARY OF THE INVENTION

Embodiments of the invention are directed to fuel cell assemblies and methods of assembling fuel cells and fuel cell stacks. A fuel cell assembly, according to embodiments of the invention, includes a first flow field plate, a second flow field plate, and a membrane electrode assembly (MEA) provided between the first and second flow field plates. The MEA includes first and second gas diffusion layers (GDLs) and a membrane provided between an anode catalytic layer and a cathode catalytic layer. A gasket is provided between the first and second flow field plates and relative to a periphery of the MEA. The gasket comprises a first surface having a first human perceivable feature associated with the anode catalytic layer and a second surface having a second human perceivable feature associated with the cathode catalytic layer. The first perceivable feature is discernable from the second perceivable feature. At least a portion of the gasket comprising the first and second human perceivable features is configured to extend beyond a periphery of the first and second flow field plates. In some embodiments, the first and second human perceivable features respectively comprise a first color and a second color discernable from the first color. In other embodiments, the first and second human perceivable features respectively comprise a first tactile feature imparted to the first surface of the gasket and second tactile feature imparted to the second surface of the gasket. The first and second human perceivable features may include combinations of visual and tactile orientation features.

According to other embodiments of the invention, a fuel cell assembly includes a first flow field plate, a second flow field plate, and a membrane electrode assembly (MEA) provided between the first and second flow field plates. The MEA includes first and second gas diffusion layers (GDLs) and a membrane provided between an anode catalytic layer and a cathode catalytic layer. A gasket is provided between the first and second flow field plates and relative to a periphery of the MEA. The gasket comprises a first colored surface associated with the anode catalytic layer and a second colored surface associated with the cathode catalytic layer. The first colored surface comprises a color discernable from a color of the second colored surface. At least a portion of the first and second colored surfaces of the gasket extend beyond a periphery of the first and second flow field plates.

In accordance with further embodiments of the invention, a method of assembling a stack of fuel cell components involves situating a first gasket provided about a perimeter of a first MEA between first and second flow field plates of a first fuel cell arrangement so that a first surface of the first gasket is oriented toward the first flow field plate. The first surface of the first gasket comprises a first human perceivable feature associated with an anode catalytic layer of the first MEA. A second surface of the first gasket includes a second human perceivable feature associated with a cathode catalytic layer of the first MEA. The first perceivable feature is discernable from the second perceivable feature. At least a portion of the first gasket comprising the first and second human perceivable features extends beyond a periphery of the first and second flow field plates.

The assembly method further involves situating a second gasket provided about a perimeter of a second MEA between third and fourth flow field plates of a second fuel cell arrangement so that a first surface of the second gasket is oriented toward the third and second flow field plates. The first surface of the second gasket comprises the first human perceivable feature associated with an anode catalytic layer of the second MEA. A second surface of the second gasket includes the second human perceivable feature associated with a cathode catalytic layer of the second MEA. At least a portion of the second gasket comprising the first and second human perceivable features extends beyond a periphery of the third and fourth flow field plates. Proper orientation of the first and second MEAs is indicated by the respective first human perceivable features of the first and second gaskets being directed toward the first and third flow field plates and the respective second human perceivable features of the first and second gaskets being directed toward the second and fourth flow field plates.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is an illustration of a fuel cell and its constituent layers;

FIG. 2 provides an exploded diagram of a fuel cell including perimeter gaskets configured in accordance with embodiments of the present invention;

FIG. 3 provides an exploded diagram of a fuel cell stack that includes unipolar and bipolar flow field plates and perimeter gaskets configured in accordance with embodiments of the invention;

FIG. 4 is a cross sectional schematic of a fuel cell assembly that employs a perimeter gasket that incorporates a user perceivable orientation indicator in accordance with embodiments of the invention;

FIG. 5 is a cross sectional schematic of a fuel cell assembly that employs a perimeter gasket that incorporates a user perceivable orientation indicator in accordance with other embodiments of the invention;

FIG. 6 is a cross sectional schematic of a fuel cell assembly that employs a perimeter gasket that incorporates a user perceivable orientation indicator in accordance with further embodiments of the invention;

FIG. 7A is a cross sectional schematic of a fuel cell assembly that employs a perimeter gasket that incorporates a user perceivable orientation indicator in accordance with various embodiments of the invention;

FIG. 7B is a cross sectional schematic of a fuel cell assembly that employs a perimeter gasket that incorporates a user perceivable orientation indicator in accordance with other embodiments of the invention;

FIG. 8A is an illustration of a perimeter gasket that incorporates a user perceivable orientation indicator in accordance with embodiments of the invention;

FIG. 8B shows a tab portion of a perimeter gasket that includes indicia in accordance with embodiments of the invention;

FIG. 8C shows a tab portion of a perimeter gasket that includes an alignment feature in accordance with embodiments of the invention;

FIG. 8D shows an alignment feature provided on a first surface (e.g., cathode side of a CCM) of a perimeter gasket in accordance with various embodiments of the invention;

FIG. 8E shows an alignment feature provided on a second surface (e.g., anode side of a CCM) of a perimeter gasket, the alignment feature of FIG. 8e configured differently from that of FIG. 8d in accordance with various embodiments of the invention;

FIG. 8F shows proper registration of the alignment features provided on the first and second surfaces of a perimeter gasket as shown in FIGS. 8d and 8e in accordance with various embodiments of the invention;

FIG. 9 is a perspective schematic of a fuel cell stack comprising fuel cell assemblies that employs a perimeter gasket that incorporates a user perceivable orientation indicator, an alignment feature, and a tab feature that facilitates electrical probing in accordance with embodiments of the invention;

FIG. 10 is a schematic of a perimeter gasket in accordance with embodiments of the invention;

FIGS. 11A and 11B respectively show first and second surfaces of a perimeter gasket that incorporates visual and tactile indicators of gasket orientation in accordance with embodiments of the invention; and

FIGS. 11C and 11D show cross sectional schematics of the orientation indicators shown in FIGS. 11A and 11B respectively taken along cross sections a-a and b-b.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that other embodiments may be utilized and structural changes may be made to the illustrated embodiments without departing from the scope of the present invention.

Embodiments of the invention are directed to a perimeter gasket configured for use in a fuel cell assembly that incorporates a user perceivable orientation indicator. In some embodiments, the perimeter gasket incorporates a visual indicator on respective first and second surfaces of the gasket to facilitate unambiguous discernment of the orientation of the gasket within a fuel cell assembly. In other embodiments, the perimeter gasket incorporates a pattern, textural, or other tactile indicator on respective first and second surfaces of the gasket to facilitate unambiguous discernment of the orientation of the gasket within a fuel cell assembly. In further embodiments, the perimeter gasket incorporates visual and tactile indicators on respective first and second surfaces of the gasket to facilitate unambiguous discernment of the orientation of the gasket within a fuel cell assembly. In other embodiments, the perimeter gasket incorporates one or more alignment features, in addition to an orientation indicator, to facilitate proper alignment of a multiplicity of gaskets within a stack of fuel cell assemblies.

Perimeter gaskets of the invention may be integrated as part of the MEA or one or both of the flow field plates. Perimeter gaskets of the invention may also be fabricated as a discrete component. For example, a perimeter gasket may be incorporated in a flow field plate via a molding process or a press-fit installation process. By way of further example, a perimeter gasket of the invention may be an extension of a subgasket that is integrally formed over the perimeter of the MEA. A subgasket may be incorporated in a perimeter gasket to reinforce the MEA by enhancing the mechanical strength of the portion of the MEA that extends into the sealing area.

According to some embodiments, a screen printing process may be used to apply resin onto the MEA to create a subgasket about the periphery of the MEA, such as the process described U.S. Patent Publication 2006/0078781 which is incorporated herein by reference. A portion or portions of this subgasket (e.g., a tab or tabs) is/are formed during the resin application process to extend beyond the sealing area of the fuel cell, such that this portion or portions extend beyond the perimeter of the flow field plates. In other embodiments, perimeter gaskets are formed by use of adhesive layers or liners disposed over the MEA.

The extended portion(s) of the MEA gasket are preferably formed or treated to include a human perceivable feature that facilitates discernment of gasket orientation within the fuel cell assembly. Examples of suitable human perceivable features include color, textures, patterns, and combinations of these and other features. In some embodiments, one or both of a first color (e.g., red) and tactile indicator is provided on a first surface of a perimeter gasket and is readily discernable by the human assembler to be associated with the anode side of the fuel cell, while one or both of a second color (e.g., blue) and tactile indicator is provided on a second surface of the perimeter gasket and is readily discernable by the human assembler to be associated with the cathode side of the fuel cell.

Current PEM electrochemical fuel cells require assembly of a substantial number of MEAs leading to a high risk of incorrect assembly. For example, a common assembly error results when the assembler incorrectly orients the anode or cathode side of the MEA toward the wrong flow field plate. Presently, there is no way to correct this MEA orientation error other than by disassembling the fuel cell stack, flipping the MEA to the correct orientation, and the re-assembling the fuel cell stack. A perimeter gasket assembly of the invention that incorporates an orientation indicator prevents such incidence of incorrect MEA orientation during assembly by providing an unambiguous perceivable indicator to the assembler of MEA orientation. In the case of a color-based indicator, for example, the assembler, when looking lengthwise down the stack, would immediately notice a red colored perimeter gasket tab extending from one of the fuel cells in the stack when all other perimeter gaskets are colored blue.

Those skilled in the art will immediately appreciate the savings in terms of cost, time, and yields that can be achieved by eliminating MEA orientation errors during fuel cell assembly by use of perimeter gaskets of the present invention. It will be appreciated that many configurations and/or combinations of features for enhancing perimeter sealing of a fuel cell assembly are contemplated. Accordingly, the specific illustrative embodiments described below are for purposes of explanation, and not of limitation.

A flow field plate of the present invention may be incorporated in fuel cell assemblies and stacks of varying types, configurations, and technologies. For example, a perimeter gasket arrangement of the present invention can be employed in proton exchange membrane (PEM) fuel cell assemblies. PEM fuel cells operate at relatively low temperatures, have high power density, can vary their output quickly to meet shifts in power demand, and are well suited for applications where quick startup is required, such as in automobiles for example.

Although generally illustrated herein in conjunction with PEM fuel cells, perimeter gasket arrangements in accordance with embodiments of the invention may also be employed in other types of fuel cells, including direct methanol fuel cells (DMFC). Direct methanol fuel cells are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at temperatures higher than those used in PEM fuel cells.

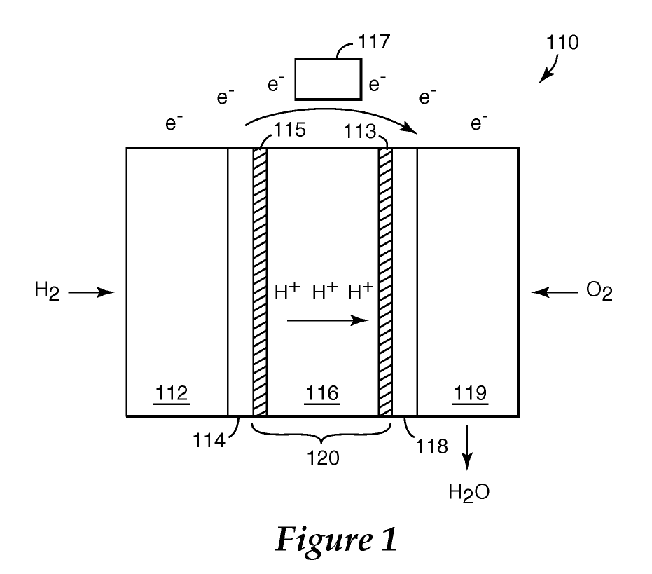

A typical proton exchange member fuel cell is depicted in FIG. 1. The fuel cell 110 shown in FIG. 1 includes a first flow field plate 112 adjacent a first gas diffusion layer (GDL) 114. Adjacent the GDL 114 is a catalyst coated membrane (CCM) 120. A second GDL 118 is situated adjacent the CCM 120, and a second flow field plate 119 is situated adjacent the second GDL 118.

In operation, hydrogen fuel is introduced into the anode portion of the fuel cell 110, passing over the first flow field separator 112 and through the GDL 114. At the interface of the GDL 114 and the CCM 120, on the surface of the catalyst layer 115, the hydrogen fuel is separated into hydrogen ions (H⁺) and electrons (e⁻).

The electrolyte membrane 116 of the CCM 120 permits only the hydrogen ions or protons and water to pass through the electrolyte membrane 116 to the cathode catalyst layer 113 of the fuel cell 110. The electrons cannot pass through the electrolyte membrane 116 and, instead, flow through an external electrical circuit in the form of electric current. This current can power an electric load 117, such as an electric motor, or be directed to an energy storage device, such as a rechargeable battery.

Oxygen flows through the second GDL 118 at the cathode side of the fuel cell 110 via the second flow field separator 119. On the surface of the cathode catalyst layer 113, oxygen, protons, and electrons combine to produce water and heat.

Individual fuel cells, such as the fuel cell shown in FIG. 1, can be combined to form a fuel cell stack. The number of fuel cells within the stack determines the total voltage of the stack, and the surface area of each of the cells determines the total current. The electrical power generated by a given fuel cell stack can be determined by multiplying the total stack voltage by total current.

Sealing fuels, coolants, and other fluids within each fuel cell in a stack is critical to the efficient operation of the fuel cell stack. Gaskets of the present invention are preferably deployed around the perimeter of the active area of the electrolyte membrane. Gaskets of the present invention may be placed on one or both surfaces of the electrolyte membrane and/or on one or both catalyst layers and/or on one or both surfaces of the gas GDLs. The gaskets are critical to seal against leaks in the peripheral areas and/or edges of the electrolyte membrane, GDLs and the flow field plates that face the GDLs. In some configurations, a sealing system may include both gaskets along with O-rings and/or other sealing arrangements. The perimeter gaskets of the present invention may be integrated as part of the MEA or one or both of the flow field plates. The perimeter gaskets may also be a discrete component.

FIG. 2 shows an exploded diagram of the components of a fuel cell that includes perimeter gaskets in accordance with embodiments of the invention. As is shown in FIG. 2, a membrane electrode assembly (MEA) 225 of the fuel cell 220 includes five component layers. An electrolyte membrane layer 222 is sandwiched between a pair of GDLs 224 and 226. An anode catalyst layer 230 is situated between a first GDL 224 and the membrane 222, and a cathode catalyst layer 232 is situated between the membrane 222 and a second GDL 226.

In one configuration, a membrane layer 222 is fabricated to include an anode catalyst coating 30 on one surface and a cathode catalyst coating 232 on the other surface. This structure is often referred to as a catalyst-coated membrane or CCM. The GDLs 224, 226 can be fabricated to include or exclude a catalyst coating. In one configuration, an anode catalyst coating 230 can be disposed partially on the first GDL 224 and partially on one surface of the membrane 222, and/or a cathode catalyst coating 232 can be disposed partially on the second GDL 226 and partially on the other surface of the membrane 222.

In the particular embodiment shown in FIG. 2, MEA 225 is shown sandwiched between a first perimeter gasket 234 and a second perimeter gasket 236. Adjacent the first and second perimeter gaskets 234 and 236 are flow field plates 240 and 242, respectively. Each of the flow field plates or separators 240, 242 includes a field of fluid flow channels 243 and ports through which hydrogen and oxygen feed fuels may pass.

In the configuration depicted in FIG. 2, flow field plates 240, 242 are configured as unipolar flow field plates, also referred to as monopolar flow field plates, in which a single MEA 225 is sandwiched therebetween. A unipolar flow field plate may comprise a separator that includes a flow field side and a cooling side. The flow field side incorporates a field of gas flow channels 243 and ports through which hydrogen or oxygen feed fuels may pass. The cooling side incorporates a cooling arrangement, such as integral cooling channels. Alternatively, the cooling side may be configured to contact a separate cooling element, such as a cooling block or bladder through which a coolant passes or a heat sink element, for example.

The edge seal systems 234, 236 provide the necessary sealing within the fuel cell to isolate the various fluid (gas/liquid) transport and reaction regions from contaminating one another and from inappropriately exiting the fuel cell 220, and may further provide for electrical isolation and/or hard stop compression control between the flow field plates 240, 242. The term “hard stop” generally refers to a nearly or substantially incompressible material that does not significantly change in thickness under operating pressures and temperatures. More particularly, the term “hard stop” refers to a substantially incompressible member or layer in a membrane electrode assembly (MEA) which halts compression of the MEA at a fixed thickness or strain.

The perimeter gaskets 234, 236, may employ one or more gaskets, sub-gaskets and/or O-rings to effect sealing of the edges of the MEA 225 and sealing between and around the MEA 225 and the flow field plates 240, 242. In one configuration, the perimeter gaskets 234, 236 include a gasket system formed from one, two or more layers of various selected materials employed to provide the requisite sealing within the fuel cell 220. Such materials include, for example, TEFLON, fiberglass impregnated with TEFLON, an elastomeric material, UV curable polymeric material, surface texture material, multi-layered composite material, sealants, and silicon material. Other configurations employ an in-situ formed seal system. As will be discussed in further detail hereinbelow, the perimeter gaskets 234, 236, which may be configured as, or incorporate, a unitary gasket structure, includes one or more portions that extend beyond the periphery of the flow field plates 240, 243 and include one or a multiplicity of indicators that allow for unambiguous discernment of gasket orientation with the fuel cell assembly/stack.

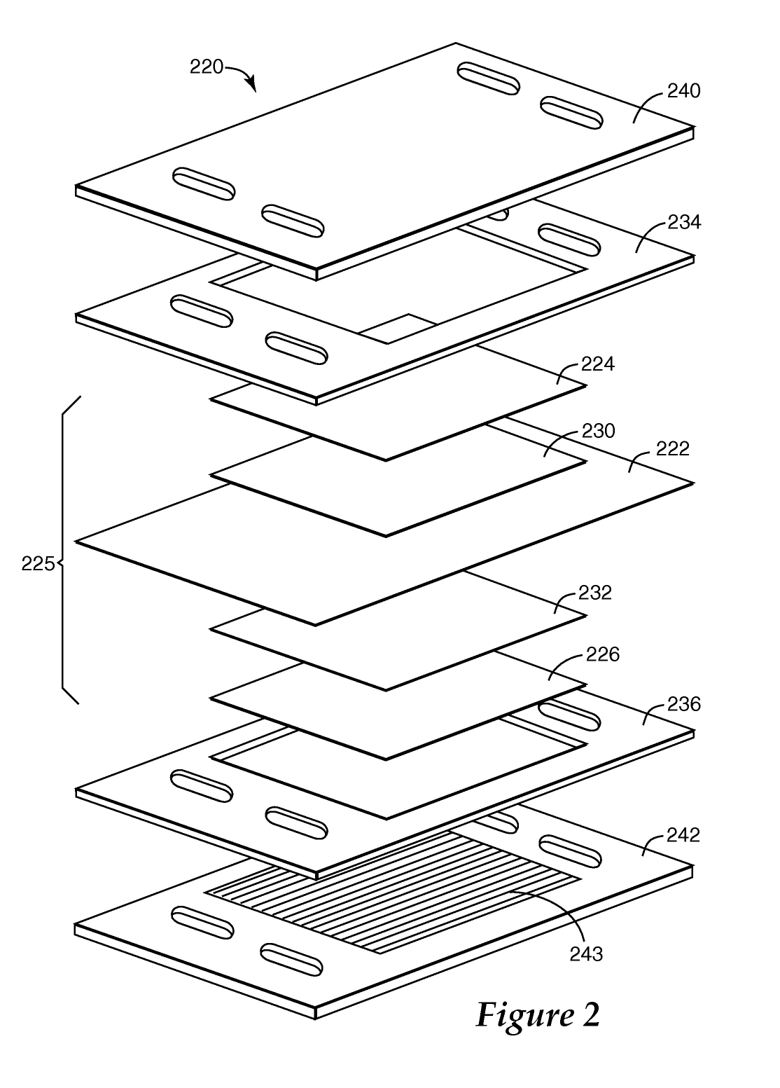

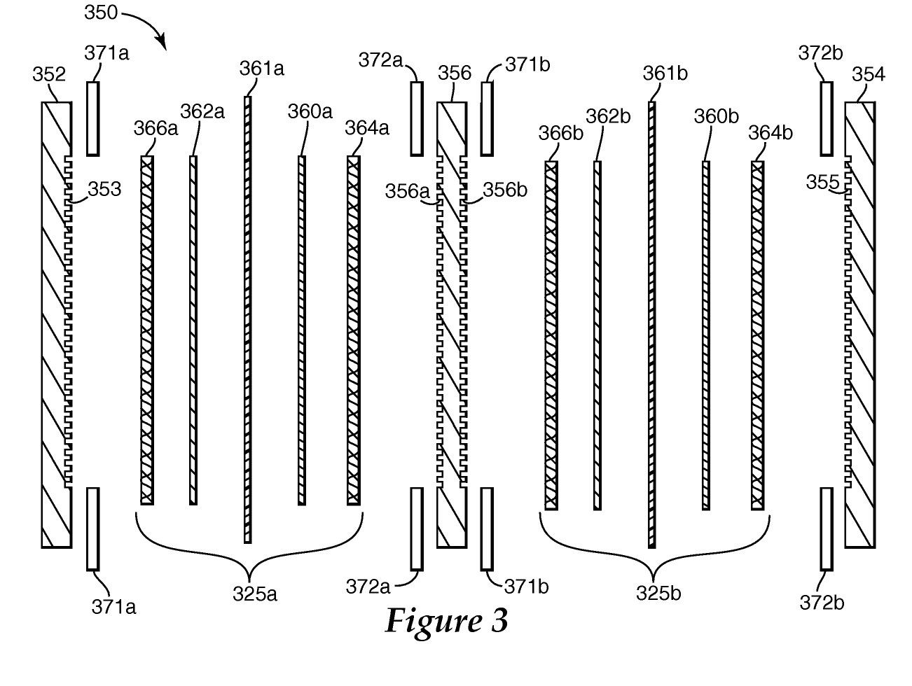

In certain embodiments, a fuel cell stack may use bipolar flow field plates, as illustrated in FIG. 3. FIG. 3 illustrates a fuel cell stack 350 which incorporates multiple MEAs 325 through employment of unipolar flow field plates 352, 354 and one or more bipolar flow field plates 356. In the configuration shown in FIG. 3, a two-cell stack 350 incorporates two MEAs 325a and 325b and a single bipolar flow field plate 356. MEA 325a includes a cathode 362a/membrane 361a/anode 360a layered structure sandwiched between GDLs 366a and 364a. GDL 366a is situated adjacent a flow field end plate 352, which is configured as a unipolar flow field plate. GDL 364a is situated adjacent a first flow field surface 356a of bipolar flow field plate 356. A perimeter gasket arrangement 371a is deployed to provide sealing for MEA 325a and flow field end plate 352. Perimeter gasket arrangement 372a is deployed to provide sealing for MEA 325 and bipolar flow field plate 356.

Similarly, MEA 325b includes a cathode 362b/membrane 361b/anode 360b layered structure sandwiched between GDLs 366b and 364b. GDL 364b is situated adjacent a flow field end plate 354, which is configured as a unipolar flow field plate. GDL 366b is situated adjacent a second flow field surface 356b of bipolar flow field plate 356. Perimeter gasket arrangements 371b and 372b are deployed to provide sealing for MEA 325b and flow field end plate 354 and MEA 325 and bipolar flow field plate 356, respectively.

It will be appreciated that in other configurations, N number of MEAs 325 and N-1 bipolar flow field plates 356 can be incorporated into an N-cell fuel cell stack.

The fuel cell and/or stack configurations shown in FIGS. 2 and 3 are representative of two particular arrangements that can be implemented for use in the context of the present invention. These arrangements are provided for illustrative purposes only, and are not intended to represent all possible configurations coming within the scope of the present invention. Rather, FIGS. 2 and 3 are intended to illustrate various components that can be selectively incorporated into fuel cell assemblies that include perimeter gasket arrangements according to principles of the present invention. Embodiments of the invention are directed to perimeter gasket arrangements that enhance human discernment of gasket orientation within a fuel cell assembly and within a fuel cell stack. As will be readily appreciated, perimeter gasket arrangements of the invention may be integrated (e.g., penetrate) into the MEA and/or the flow field plate(s), or be installed as a discrete gasket component.

Perimeter gaskets of the present invention may be incorporated in a unitized fuel cell assembly (UCA). The term unitized fuel cell system refers to a unitary module or unit that comprises one or more cells that can work as a functioning fuel cell alone or in conjunction with other UCA's in a stack. The number of UCAs within the stack determines the total voltage of the stack, and the active surface area of each of the cells determines the total current. The total electrical power generated by a given fuel cell stack can be determined by multiplying the total stack voltage by total current. A UCA packaging approach consistent with embodiments of the invention provides for efficient assembling and disassembling of fuel cell stacks and, further, provides for recycling of various UCA components.

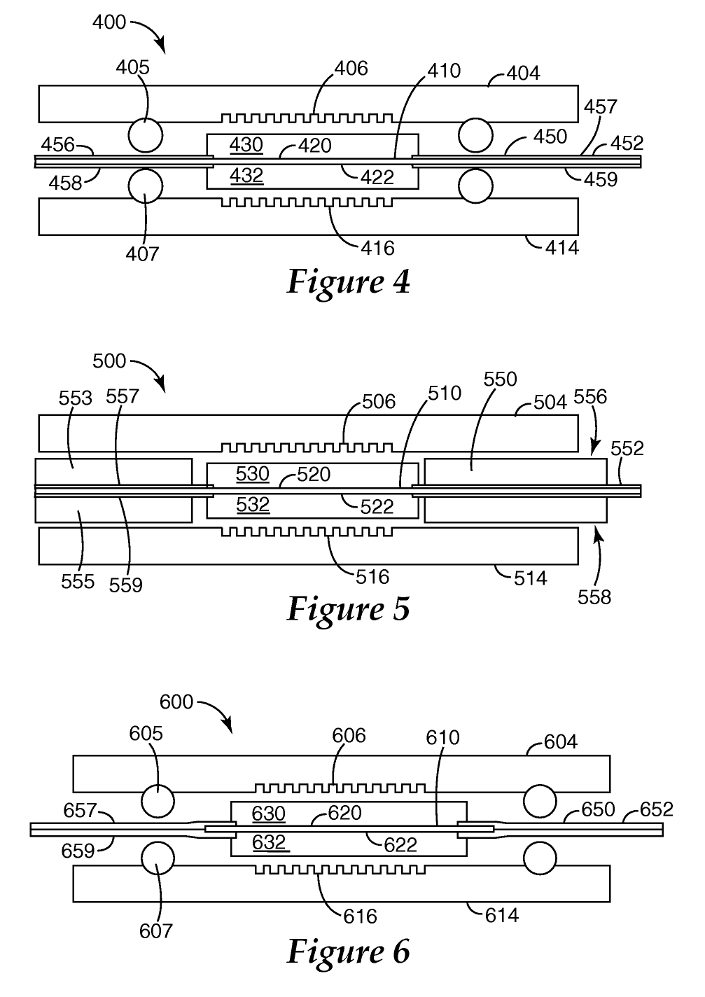

FIG. 4 is a cross sectional schematic of a fuel cell assembly that employs a perimeter gasket that incorporates a user perceivable orientation indicator in accordance with embodiments of the invention. The fuel cell assembly 400 shown in FIG. 4 includes an MEA 410 that incorporates an anode catalyst layer 420 and a cathode catalyst layer 422. The MEA 410 is shown sandwiched between a first GDL 430 and a second GDL 432. Situated adjacent the first GDL 430 are flow field channels 406 of a first flow field plate 404, and situated adjacent the second GDL 432 are flow field channels 416 of a second flow field plate 414.

A gasket 450 is shown disposed about the perimeter of the MEA 410. According to some embodiments, the gasket 450 may be configured as a subgasket that is integral to the MEA 410. For example, the gasket 450 may be formed from a suitable resin during the aforementioned screen printing process. In other embodiments, the gasket 450 shown in FIG. 4 may be formed by use of an adhesive layer or liner disposed over the MEA 410. The adhesive layers 457, 459 may comprise a pressure sensitive adhesive (PSA), a heat activated adhesive, a UV activated adhesive, or other type of adhesive. For example, the adhesive layers 457, 459 may comprise any of the following: acrylic PSA's, rubber based adhesives, ethylene maleic anhydride copolymers, olefin adhesives such as copolymers of 1-octene with ethylene or propylene, nitrile based adhesives, epoxy based adhesives, and urethane based adhesives. In other embodiments, the adhesive layers 457, 459 may comprise a thermally activated adhesive, such as Thermobond 845 (polyethylene maleate based) and Thermobond 583 (nitrile rubber based). O-ring or other type of gaskets 405, 407 are preferably provided in the first and second flow field plates 404, 414, respectively. The gaskets 405, 407 may be formed by a molding process or by a press-fitting process by which preformed gaskets are press fit into a channel formed in the first and second flow field plates 404, 414, respectively.

The gasket 450 has a first surface 456 and a second surface 458. The gasket 450 includes a portion 452 that is configured to extend beyond the periphery of the flow field plates 404, 414. The first and second surfaces 456, 458 are preferably provided with a visual and/or tactile orientation indicator feature that allows an assembler to readily discern the anode side 420 of the MEA 410 from the cathode side 422 of the MEA 410. At least the outwardly extending portion 452 of the gasket 450 is provided with the visual and/or tactile orientation indicator feature, it being understood that other portions or the entirety of the first and second surfaces 456, 458 of the gasket 450 may be provided with the visual and/or tactile orientation indicator feature.

FIG. 5 is a cross sectional schematic of a fuel cell assembly that employs a perimeter gasket that incorporates a user perceivable orientation indicator in accordance with other embodiments of the invention. The fuel cell assembly 500 shown in FIG. 5 includes an MEA 510 that incorporates an anode catalyst layer 520 and a cathode catalyst layer 522. The MEA 510 is disposed between first and second GDLs 530 and 532. Adjacent the first and second GDLs 530 and 532 are flow field channels 506 and 516 of first and second flow field plates 504 and 514, respectively.

A gasket 550, shown disposed about the perimeter of the MEA 510, is configured as a perimeter gasket arrangement that is preferably non-integral to the MEA 510. In the embodiment shown in FIG. 5, the gasket 550 incorporates an adhesive 557, 559 with or without a liner, and further incorporates a hard stop arrangement 553, 555. The hard stop arrangement 553, 555 is dimensioned to control compressive forces imparted to the MEA upon establishment of contact between the first and second flow field plates under pressure. The hard stop arrangement 553, 555 is preferably formed from a nearly or substantially incompressible material that does not significantly change in thickness under operating pressures and temperatures. Generally, the hard stop arrangement 553, 555 includes a substantially incompressible member or layer in the MEA 510 that halts compression of the MEA 510 at a fixed thickness or strain. The hard stop arrangement 553, 555 is generally not part of the ion conducting membrane layer, a catalyst layer, or a gas diffusion layer.

The gasket 550 has first and second surfaces 556 and 558, at least a portion 552 of which is configured to extend beyond the periphery of the flow field plates 504, 514. At least the outwardly extending portion 552 of the gasket 550 is provided with a visual and/or tactile orientation indicator feature, although other portions or the entirety of the first and second surfaces 556, 558 of the gasket 550 may be provided with the visual and/or tactile orientation indicator feature.

FIG. 6 is a cross sectional schematic of a fuel cell assembly that employs a perimeter gasket that incorporates a user perceivable orientation indicator in accordance with further embodiments of the invention. According to the embodiment shown in FIG. 6, a fuel cell assembly 600 includes an MEA 610 that incorporates an anode catalyst layer 620, a cathode catalyst layer 622, and is disposed between first and second GDLs 630 and 632. Adjacent the first and second GDLs 630 and 632 are flow field channels of first and second flow field plates 604 and 614, respectively. O-ring or other type of gaskets 605, 607 are preferably provided in the first and second flow field plates 604, 614, respectively.

The gasket arrangement of FIG. 6 includes a perimeter gasket 650 that is shown disposed about the perimeter of the MEA 610. The MEA 610 of FIG. 6 is shown to incorporate an adhesive liner 657, 659 bonded to the CCM 610/620/622 to form the perimeter gasket 650. At least the outwardly extending portion 662 of the perimeter gasket 650 is provided with a visual and/or tactile orientation indicator feature.

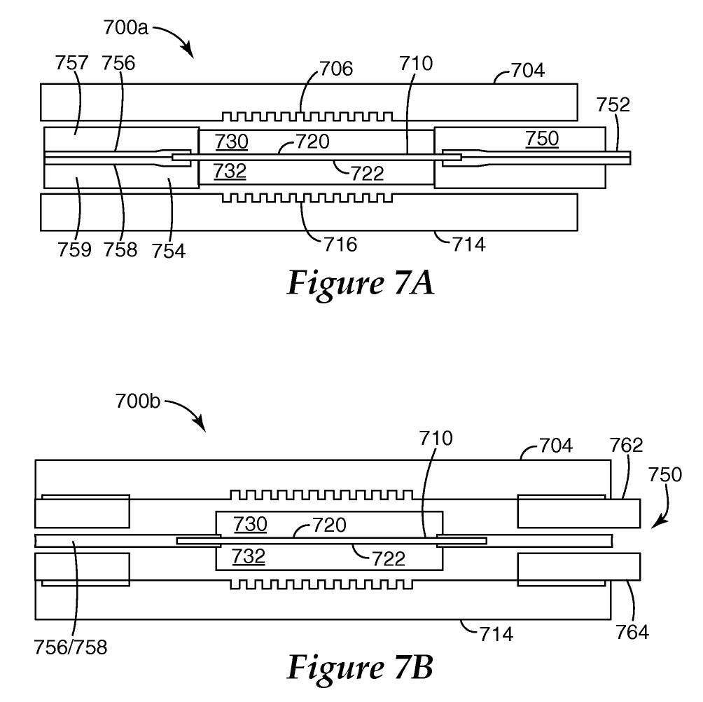

FIG. 7A is a cross sectional schematic of a fuel cell assembly that employs a perimeter gasket that incorporates a user perceivable orientation indicator in accordance with further embodiments of the invention. In the embodiment shown in FIG. 7A, a fuel cell assembly 700a includes an MEA 710 that incorporates an anode catalyst layer 720, a cathode catalyst layer 722, and is disposed between first and second GDLs 730 and 732. Adjacent the first and second GDLs 730 and 732 are flow field channels of first and second flow field plates 704 and 714, respectively.

The gasket arrangement of FIG. 7A includes a perimeter gasket 750 that is shown disposed about the perimeter of the MEA 710. The MEA 710 of FIG. 7 is shown to incorporate an adhesive layer 756, 758 with a liner 757, 759 bonded onto the CCM 710/720/722 to form the perimeter gasket 750. At least the outwardly extending portion 752 of the perimeter gasket 750 is provided with a visual and/or tactile orientation indicator feature. The outwardly extending portion 752 of the perimeter gasket 750 may include one or both of an outwardly extending portion of the adhesive layer 756, 758 and an outwardly extending portion of the liner 757, 759.

FIG. 7B is a cross sectional schematic of a fuel cell assembly that employs a perimeter gasket that incorporates a user perceivable orientation indicator in accordance with further embodiments of the invention. In the embodiment shown in FIG. 7B, a fuel cell assembly 700b includes an MEA 710 that incorporates an anode catalyst layer 720, a cathode catalyst layer 722, and is disposed between first and second GDLs 730 and 732. Adjacent the first and second GDLs 730 and 732 are flow field channels of first and second flow field plates 704 and 714, respectively.

The gasket arrangement of FIG. 7B includes a perimeter gasket 750 that is formed by an adhesive layer 756/758 (with or without a liner) bonded onto the CCM 710/720/722. In other configurations, the CCM 710/720/722 may be formed or treated to incorporate an integral subgasket in addition to, or to the exclusion of, the adhesive layer 756/758. The perimeter gasket 750 also includes first and second gaskets 762, 764 that are formed into or on the first and second flow field plates 704, 714, respectively. The gaskets 762, 764 may be formed by a molding process or by a press-fitting process by which preformed gaskets are press fit into a channel formed in the first and second flow field plates 704, 714, respectively. At least an outwardly extending portion of the perimeter gasket 750 is provided with a visual and/or tactile orientation indicator feature. The respective first and second surfaces of the CCM 710/720/722 may also include a visual and/or tactile orientation indicator feature that can be used with the visual and/or tactile orientation indicator feature of the perimeter gasket 750 to ensure proper orientation and alignment during fuel cell assembly.

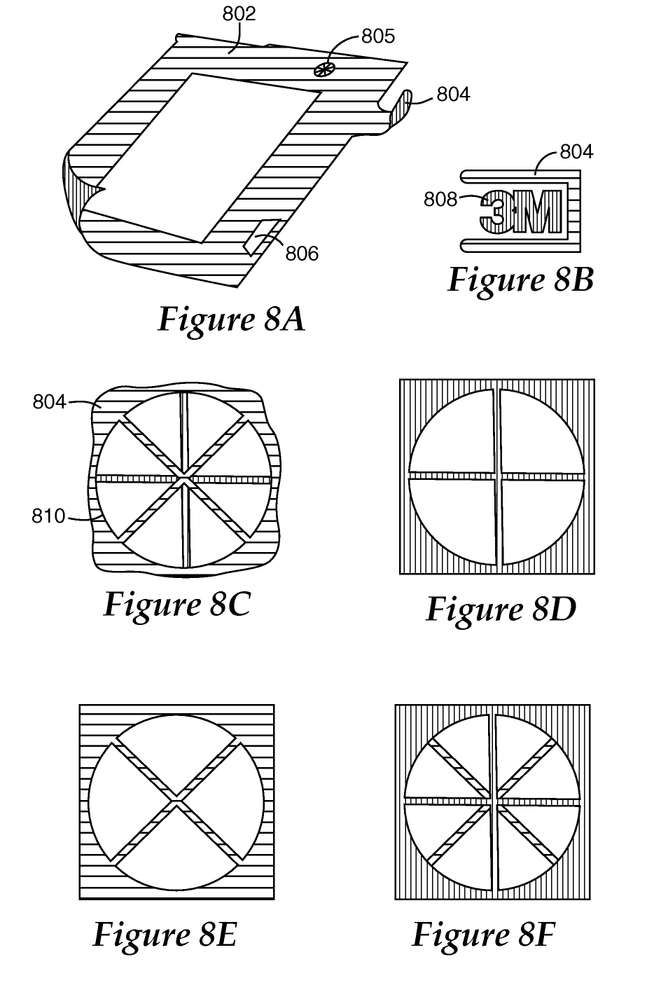

FIG. 8A is an illustration of a perimeter gasket that incorporates a user perceivable orientation indicator in accordance with embodiments of the invention. The gasket 802 shown in FIG. 8A includes a tab 804 that shown folder over to expose the lower surface of the gasket 802. A corner portion of the gasket 802 is also folder over to expose the lower surface of the gasket 802. The upper surface of the gasket 802, in this illustration, includes a first color (e.g., blue) and the lower surface of the gasket 802 includes a second color (e.g., red) discernable from the first color. The tab 804 may include indicia, such as a manufacturer's logo 808 as shown in FIG. 8B. Indicia incorporated on tab 804 may include identifying information (e.g., lot number, serial number, etc.) that uniquely identify the MEA and/or the fuel cell that is associated with the gasket 802.

The gasket 802 may also include one or more alignment features that facilitate proper alignment of the gasket 802 during fuel cell assembly. The gasket 802 is shown to include two such alignment features 805 and 806. Alignment feature 805 is located on the gasket 802 to facilitate proper alignment or indexing of the gasket 802 relative to the flow field plates. The alignment feature 805 may be a hole or other apertured portion of the gasket 802. The alignment feature 805 is typically not visible after assembling of the fuel cell has been completed. Alignment feature 806 is configured as a windowed portion of the gasket 806. The alignment feature 806 is configured to extend beyond the periphery of the flow field plates to facilitate visual inspection of the relative alignment of the gasket 802 within the fuel cell and with respect to a multiplicity of other fuel cell gaskets 802 of the a fuel cell stack. Other alignment features may be incorporated into the gasket 802, such as alignment feature 810 provided in the tab 804 as shown in FIG. 8C. It is noted that identifying information (e.g., lot number, serial number, etc.) that uniquely identifies the MEA and/or the fuel cell that is associated with the gasket 802 may be incorporated at portions of the gasket 802 other than at the tab 804, such as at the windowed portion 806 of the gasket.

FIG. 8D shows an alignment feature 805/810 that may be provided on a first surface of the gasket 802 of FIG. 8A in accordance with various embodiments of the invention. FIG. 8E shows an alignment feature 805/810 differing in configuration from that shown in FIG. 8D, which may be provided on a second surface of the gasket 802 shown in FIG. 8A. The alignment feature 805/810 of FIG. 8D may be associated with the cathode side of the MEA and colored red, for example. The alignment feature 805/810 of FIG. 8E may be associated with the anode side of the MEA and colored blue, for example. FIG. 8F shows proper axial registration of the alignment features 805/810 provided on the first and second surfaces of the gasket 802. In the embodiment shown in FIGS. 8D-8F, both the color and the pattern of the alignment features 805/810 provide for enhanced visual evaluation and confirmation of proper alignment.

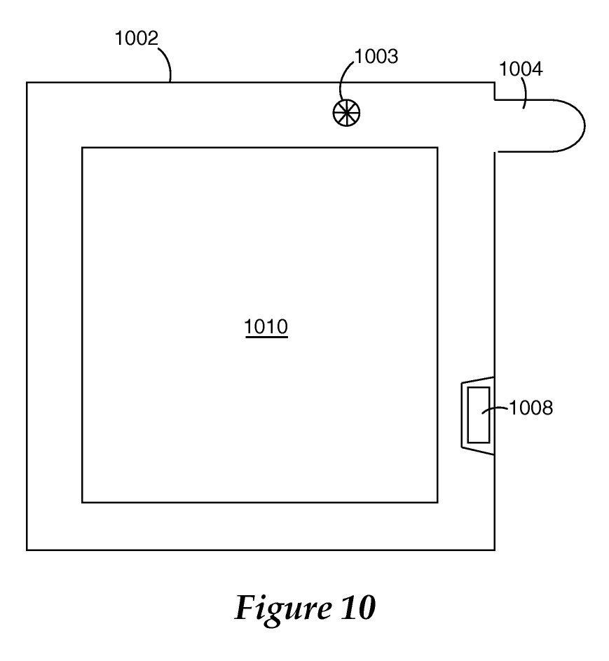

The gasket 802 shown in FIG. 8A may be configured as a pre-formed gasket, a subgasket integral to an MEA, or a gasket arrangement integral to one or more flow field plates. FIG. 10, for example, illustrates a gasket 1002 that has features similar to those of gasket 802 shown in FIG. 8A. The gasket 1002 shown in FIG. 10 is configured as a subgasket that is integral to an MEA 1010. The gasket 1002 may be formed about MEA 1010 using the aforementioned screen printing process. The gasket 1002 is shown to include a tab 1004 that is configured to extend beyond the periphery of the flow field plates. The gasket 1002 also includes a first alignment feature 1003 and a windowed alignment feature 1008.

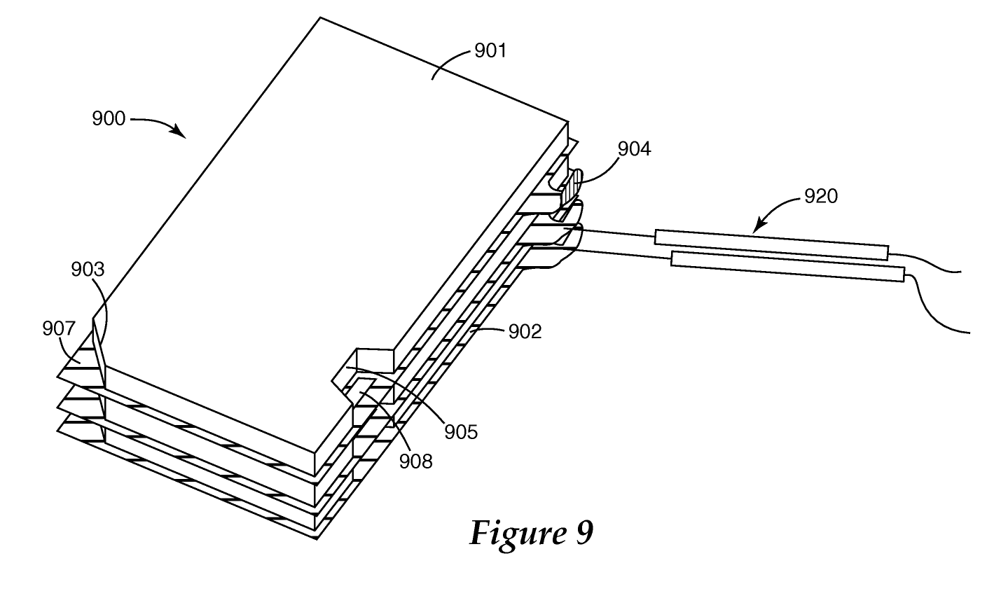

FIG. 9 shows a stack 900 of fuel cell assemblies 901 that incorporate perimeter gaskets of the present invention. The stack 900 may include conventional fuel cell components that include perimeter gaskets of the present invention or UCAs that incorporate perimeter gaskets of the present invention. The fuel cell assemblies 901 shown in FIG. 9 include flow field plates that have a recessed portion 905 which correspond in shape to the windowed portion 908 of the perimeter gaskets 902. Proper alignment and orientation of the gaskets 902 and, therefore, MEAs may be assessed by the assembler peering down a line of sight through the gasket windows 908. Proper alignment and orientation of the gaskets 902 may also be assessed by observing the corners 907 of the gaskets 902 that extend beyond the cut corner 907 of the flow field plates.

Each of the perimeter gaskets 902 shown in FIG. 9 includes a tab 904 that facilitates access to electrically active portions of the fuel cells by a pair of electrically conductive probes 920. The gasket 902 is formed from electrically non-conductive material, thereby providing electrical insulation between the probes 920. Accordingly, the electrical characteristics of each fuel cell assembly 901 of the stack 900 can be evaluated using the probes 920 without the occurrence of shorting between the probes 920.

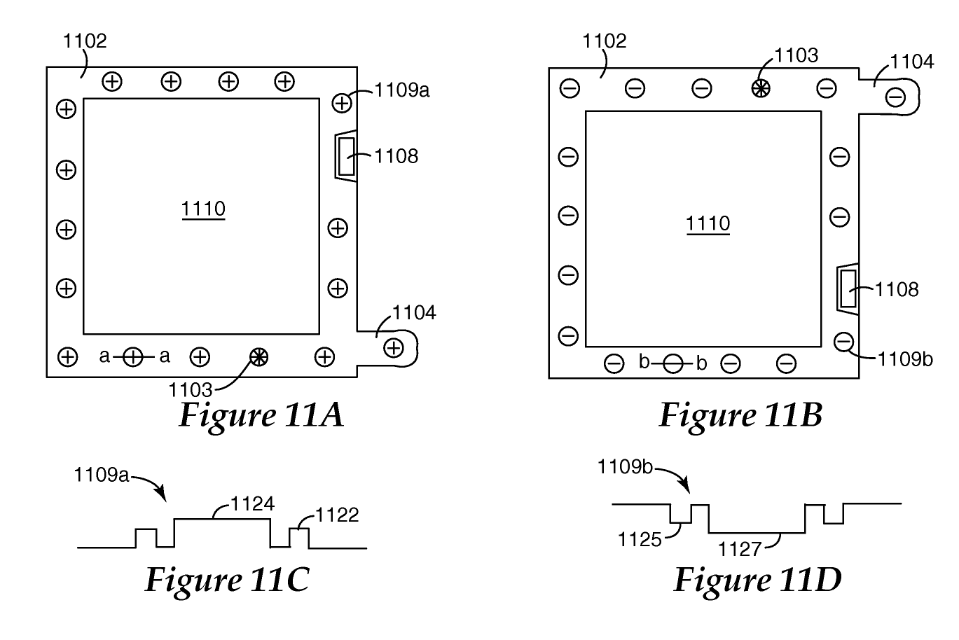

FIGS. 11A and 11B respectively show first and second surfaces of a perimeter gasket 1102 that incorporates visual and/or tactile indicators 1109a, 1109b for discerning gasket orientation in accordance with embodiments of the invention. In some embodiments, the orientation of the cathode and anode sides of the MEA 1110 may be indicated by positive and negative symbols 1109a and 1109b, respectively. These symbols may be printed or otherwise incorporated onto the respective first and second surfaces of the gasket 1102. In other embodiments, tactile indicators of different configuration may be impressed on the respective first and second surfaces of the gasket 1102. FIGS. 11C and 11D show cross sectional schematics of the orientation indicators shown in FIGS. 11A and 11B respectively taken along cross sections a-a and b-b in accordance with embodiments of the invention. The positive polarity indicators 1109a shown in FIG. 11A may have a protruding profile that would feel like raised bumps to the touch. The negative polarity indicators 1109b shown in FIG. 11B may have a recessed profile that would feel like depressions or pits to the touch. The tactile indicators 1109a and 1109b may also serve as visual orientation indicators. Colors or other patterns may also be incorporated onto the first and second surfaces of the gasket to serve as visual and/or tactile orientation indicators.

With regard to various details concerning PEM fuel cells within which a perimeter gasket and/or sealing methodology of the present invention may be utilized, any suitable electrolyte membrane may be used in the practice of the present invention. Useful PEM thicknesses range between about 200 μm and about 15 μm. Copolymers of tetrafluoroethylene (TFE) and a co-monomer according to the formula: FSO2—CF2—CF2—O—CF(CF3)—CF2—O—CF═CF2 are known and sold in sulfonic acid form, i.e., with the FSO2— end group hydrolyzed to HSO3—, under the trade name NAFION® by DuPont Chemical Company, Wilmington, Del. NAFION® is commonly used in making polymer electrolyte membranes for use in fuel cells. Copolymers of tetrafluoroethylene (TFE) and a co-monomer according to the formula: FSO2—CF2—CF2—O—CF═CF2 are also known and used in sulfonic acid form, i.e., with the FSO2— end group hydrolyzed to HSO3—, in making polymer electrolyte membranes for use in fuel cells. Most preferred are copolymers of tetrafluoroethylene (TFE) and FSO2—CF2CF2CF2CF2—O—CF═CF2, with the FSO2— end group hydrolyzed to HSO3—. Other materials suitable for PEM construction are described in commonly owned U.S. patent application Ser. No. 11/225,690 filed 13 Sep. 2005 which is incorporated herein by reference.

In some embodiments, the catalyst layers may comprise Pt or Pt alloys coated onto larger carbon particles by wet chemical methods, such as reduction of chloroplatinc acid. This form of catalyst is dispersed with ionomeric binders and/or solvents to form an ink, paste, or dispersion that is applied either to the membrane, a release liner, or GDL.

In some embodiments, the catalyst layers may comprise nanostructured support elements bearing particles or nanostructured thin films (NSTF) of catalytic material. Nanostructured catalyst layers do not contain carbon particles as supports and therefore may be incorporated into very thin surface layers of the electrolyte membrane forming a dense distribution of catalyst particles. The use of nanostructured thin film (NSTF) catalyst layers allows much higher catalyst utilization than catalyst layers formed by dispersion methods, and offer more resistance to corrosion at high potentials and temperatures due to the absence of carbon supports. In some implementations, the catalyst surface area of a CCM may be further enhanced by using an electrolyte membrane having microstructured features. Various methods for making microstructured electrolyte membranes and NSTF catalyst layers are described in the following commonly owned patent documents which are incorporated herein by reference: U.S. Pat. Nos. 4,812352, 5,879,827, and 6,136,412 and U.S. patent application Ser. No. 11/225,690 filed Sep. 13, 2005 and U.S. Ser. No. 11/224,879, filed Sep. 13, 2005.

NSTF catalyst layers comprise elongated nanoscopic particles that may be formed by vacuum deposition of catalyst materials on to acicular nanostructured supports. Nanostructured supports suitable for use in the present invention may comprise whiskers of organic pigment, such as C.I. PIGMENT RED 149 (perylene red). The crystalline whiskers have substantially uniform but not identical cross-sections, and high length-to-width ratios. The nanostructured support whiskers are coated with coating materials suitable for catalysis, and which endow the whiskers with a fine nanoscopic surface structure capable of acting as multiple catalytic sites.

The nanostructured support elements are coated with a catalyst material to form a nanostructured thin film catalyst layer. According to one implementation, the catalyst material comprises a metal, such as a platinum group metal. In one embodiment, the catalyst coated nanostructured support elements may be transferred to a surface of an electrolyte membrane to form a catalyst coated membrane. In another embodiment, the catalyst coated nanostructured support elements maybe formed on a GDL surface.

The GDLs can be any material capable of collecting electrical current from the electrode while allowing reactant gasses to pass through, typically a woven or non-woven carbon fiber paper or cloth. The GDLs provide porous access of gaseous reactants and water vapor to the catalyst and membrane, and also collect the electronic current generated in the catalyst layer for powering the external load.

The GDLs may include a microporous layer (MPL) and an electrode backing layer (EBL), where the MPL is disposed between the catalyst layer and the EBL. EBLs may be any suitable electrically conductive porous substrate, such as carbon fiber constructions (e.g., woven and non-woven carbon fiber constructions). Examples of commercially available carbon fiber constructions include trade designated “AvCarb P50” carbon fiber paper from Ballard Material Products, Lowell, Mass.; “Toray” carbon paper which may be obtained from ElectroChem, Inc., Woburn, Mass.; “SpectraCarb” carbon paper from Spectracorp, Lawrence, Mass.; “AFN” non-woven carbon cloth from Hollingsworth & Vose Company, East Walpole, Mass.; and “Zoltek” carbon cloth from Zoltek Companies, Inc., St. Louis, Mo. EBLs may also be treated to increase or impart hydrophobic properties. For example, EBLs may be treated with highly-fluorinated polymers, such as polytetrafluoroethylene (PTFE) and fluorinated ethylene propylene (FEP).

The carbon fiber constructions of EBLs generally have coarse and porous surfaces, which exhibit low bonding adhesion with catalyst layers. To increase the bonding adhesion, the microporous layer may be coated to the surface of EBLs. This smoothens the coarse and porous surfaces of EBLs, which provides enhanced bonding adhesion with some types of catalyst layers.

The foregoing description of the various embodiments of the invention has been presented for the purposes of illustration and description. It is not intended to be exhaustive or to limit the invention to the precise form disclosed. Many modifications and variations are possible in light of the above teaching. For example, orientation indicators described herein may be configured for discernment by a computer-based vision system, which can be configured to discern MEA/gasket orientation and alignment using known visioning techniques. Although considered desirable, the orientation and/or alignment features need not be perceptible to the human assembler in such automated embodiments. It is intended that the scope of the invention be limited not by this detailed description, but rather by the claims appended hereto.

What we claim is:

1. A fuel cell assembly, comprising:
a first flow field plate;
a second flow field plate;
a membrane electrode assembly (MEA) provided between the first and second flow field plates, the MEA comprising first and second gas diffusion layers (GDLs) and a membrane provided between an anode catalytic layer and a cathode catalytic layer; and
a gasket provided between the first and second flow field plates and relative to a periphery of the MEA, the gasket comprising a first colored surface associated with the anode catalytic layer and a second colored surface associated with the cathode catalytic layer, the first colored surface comprising a color discernable from a color of the second colored surface, at least a portion of the first and second colored surfaces of the gasket extending beyond a periphery of the first and second flow field plates.

2. The assembly of claim 1, wherein the color of one of the first and second colored surfaces comprises a color of a material from which the gasket is formed, and the color of the other of the first and second colored surfaces comprises a color of a colored additive or a colored coating.

3. The assembly of claim 1, wherein the gasket comprises an alignment feature configured to facilitate alignment of the gasket relative to one or both of the first and second flow field plates.

4. The assembly of claim 1, wherein the portion of the first and second colored surfaces of the gasket comprises a tab extending outwardly relative to the periphery of the first and second flow field plates.

5. The assembly of claim 4, wherein the tab comprises an alignment feature configured to facilitate alignment of a plurality of the gaskets of a stack of the fuel cell assemblies.

6. The assembly of claim 4, wherein the tab comprises indicia that uniquely identifies one or both of the MEA and the fuel cell assembly.

7. The assembly of claim 1, wherein the gasket is formed from an electrically non-conducting material, the portion of the gasket extending beyond the periphery of the first and second flow field plates configured to facilitate access to electrically active portions of the fuel cell by a pair of electrically conductive probes while preventing shorting between the probes.

8. The assembly of claim 1, wherein the gasket is integral to the MEA.

9. The assembly of claim 1, wherein one of the gaskets is integral to each of the first and second flow field plates.

10. The assembly of claim 9, further comprising a subgasket provided adjacent the gasket and configured to enhance mechanical strength of the MEA.

11. The assembly of claim 1, wherein portions of the first and second colored surfaces of the gasket extend beyond the periphery of the first and second flow field plates, the respective portions comprising two or more tabs extending outwardly relative to the periphery of the first and second flow field plates, at least one of the two or more tabs comprising an alignment feature configured to facilitate alignment of a plurality of the gaskets of a stack of the fuel cell assemblies.

12. The assembly of claim 1, wherein the fuel cell is a unitized fuel cell assembly (UCA).

13. A fuel cell assembly, comprising:
a first flow field plate;
a second flow field plate;
a membrane electrode assembly (MEA) provided between the first and second flow field plates, the MEA comprising first and second gas diffusion layers (GDLs) and a membrane provided between an anode catalytic layer and a cathode catalytic layer; and
a gasket provided between the first and second flow field plates and relative to a periphery of the MEA, the gasket comprising a first surface having a first human perceivable feature associated with the anode catalytic layer and a second surface having a second human perceivable feature associated with the cathode catalytic layer, the first perceivable feature discernable from the second perceivable feature, at least a portion of the gasket comprising the first and second human perceivable features extending beyond a periphery of the first and second flow field plates.

14. The assembly of claim 13, wherein the first and second human perceivable features respectively comprise a first color and a second color discernable from the first color.

15. The assembly of claim 13, wherein the first and second human perceivable features respectively comprise a first tactile feature imparted to the first surface of the gasket and second tactile feature imparted to the second surface of the gasket.

16. The assembly of claim 13, wherein the first human perceivable feature comprises a first tactile feature and a first color imparted to the first surface of the gasket and the second human perceivable feature comprises a second tactile feature and a second color imparted to the second surface of the gasket, the second tactile feature discernable from the first tactile feature, and the second color discernable from the first color.

17. The assembly of claim 16, where the portion of the gasket comprising the first and second human perceivable features extending beyond the periphery of the first and second flow field plates further comprises an alignment feature configured to facilitate alignment of a plurality of the gaskets of a stack of the fuel cell assemblies.

18. A method of assembling a stack of fuel cell components, comprising:
situating a first gasket provided about a perimeter of a first membrane electrode assembly (MEA) between first and second flow field plates of a first fuel cell arrangement so that a first surface of the first gasket is oriented toward the first flow field plate, the first surface of the first gasket having a first human perceivable feature associated with an anode catalytic layer of the first MEA and a second surface of the first gasket having a second human perceivable feature associated with a cathode catalytic layer of the first MEA, the first perceivable feature discernable from the second perceivable feature, at least a portion of the first gasket comprising the first and second human perceivable features extending beyond a periphery of the first and second flow field plates; and
situating a second gasket provided about a perimeter of a second MEA between third and fourth flow field plates of a second fuel cell arrangement so that a first surface of the second gasket is oriented toward the third and second flow field plates, the first surface of the second gasket comprising the first human perceivable feature associated with an anode catalytic layer of the second MEA and a second surface of the second gasket having the second human perceivable feature associated with a cathode catalytic layer of the second MEA, at least a portion of the second gasket comprising the first and second human perceivable features extending beyond a periphery of the third and fourth flow field plates;
wherein proper orientation of the first and second MEAs is indicated by the respective first human perceivable features of the first and second gaskets being directed toward the first and third flow field plates and the respective second human perceivable features of the first and second gaskets being directed toward the second and fourth flow field plates.

19. The method of claim 18, wherein each of the first and second gaskets comprises an alignment feature provided on a portion of the first and second gaskets that are encompassed by the first, second, third, and fourth flow field plates, the method further comprising aligning the first and second MEAs based on alignment of the alignment feature of the first gasket relative to at least one the first and second flow field plates and the alignment feature of the second gasket relative to at least one of the third and fourth flow field plates.

20. The method of claim 18, wherein each of the first and second gaskets comprises an alignment feature provided on the portion of the first and second gaskets that extend beyond the periphery of the first, second, third, and fourth flow field plates, the method further comprising aligning the first and second MEAs based on alignment of the respective alignment features of the first and second gaskets.
